(19) United States
(12) Patent Application Publication
(10) Pub. No.: US 2017/0011652 A1
(43) Pub. Date: Jan. 12, 2017

(54) MOTION ANALYSIS METHOD, MOTION ANALYSIS APPARATUS, MOTION ANALYSIS SYSTEM, AND PROGRAM

(71) Applicant: SEIKO EPSON CORPORATION, Tokyo (JP)

(72) Inventors: Kenya KODAIRA, Azumino-shi (JP); Kazuhiro SHIBUYA, Shiojiri-shi (JP)

(73) Assignee: SEIKO EPSON CORPORATION, Tokyo (JP)

(21) Appl. No.: 15/114,284

(22) PCT Filed: Mar. 16, 2015
(86) PCT No.: PCT/JP2015/001451

§ 371 Date: Jul. 26, 2016

(30) Foreign Application Priority Data
Mar. 25, 2014 (JP) 2014-061908

(51) Int. Cl. G09B 19/00

(52) U.S. Cl. CPC G09B 19/0038

(57) ABSTRACT

A motion analysis method, a motion analysis apparatus, a motion analysis system, and a program, capable of presenting attitude information of an exercise appliance when a subject holds the exercise appliance. A motion analysis method includes a rotation angle computation step of computing a rotation angle θ about a long axis of a shaft of a golf club when a subject holds the golf club, by using outputs from a sensor unit attached to the golf club, and an initial attitude information generation step of generating initial attitude information regarding an initial attitude of the golf club by using the rotation angle θ.

### TECHNICAL FIELD

The present invention relates to a motion analysis method, a motion analysis apparatus, a motion analysis system, and a program, for analyzing motion of a subject.

### BACKGROUND ART

In the related art, there is a camera system in which an image of a golf swing is captured, and the swing is analyzed on the basis of the captured image, but, in such a camera system, since a large-scale apparatus is necessary, an installation location is selected, and thus simple measurement cannot be performed, and convenience deteriorates. In contrast, PTL 1 proposes an apparatus in which a three-axis acceleration sensor and a three-axis gyro sensor are attached to a golf club, and a swing is analyzed by using outputs from the sensors, and, if the apparatus is used, a camera is not necessary, and convenience is improved.

### CITATION LIST

### Patent Literature

PTL 1: JP-A-2008-73210

### SUMMARY OF INVENTION

### Technical Problem

Meanwhile, in a golf swing, an address attitude is one of the factors to determine whether or not ball hitting is appropriately performed. For example, in addition to an address attitude of making a shaft vertical to a hit ball direction, an address attitude called a hand-first attitude may be also taken in which a loft of a club head is raised, and the shaft is laid in a hit ball direction. However, in a swing analysis apparatus of the related art using an inertial sensor, a difference in an initial attitude of a golf club due to a difference in an address attitude for each subject is not taken into consideration. Thus, for example, a highly accurate analysis result is not necessary obtained depending on an address attitude of a subject, or a subject cannot objectively understand to what extent the subject takes a hand-first attitude.

The invention has been made in consideration of the above-described problems, and, according to some aspects of the invention, it is possible to provide a motion analysis method, a motion analysis apparatus, a motion analysis system, and a program, capable of presenting attitude information of an exercise appliance when a subject holds the exercise appliance.

### Solution to Problem

The invention has been made in order to solve at least some of the above-described problems, and can be realized in the following aspects or application examples.

### APPLICATION EXAMPLE 1

A motion analysis method according to this application example includes a rotation angle computation step of computing a rotation angle about a long axis of a shaft of an exercise appliance when a subject holds the exercise appliance, by using outputs from an inertial sensor attached to the exercise appliance; and an initial attitude information generation step of generating initial attitude information regarding an initial attitude of the exercise appliance by using the rotation angle.

The exercise appliance is an appliance used to hit a ball, such as a golf club, a tennis racket, a baseball bat, and a hockey stick. The shaft is a shaft portion of the exercise appliance, and also includes grip portion in an exercise appliance having the grip portion.

The inertial sensor may be a sensor which can measure an inertial amount such as acceleration or angular velocity, and may be, for example, an inertial measurement unit (IMU) which can measure acceleration or angular velocity. The inertial sensor may be attachable to and detachable from an exercise appliance, and may be fixed to an exercise appliance so as to not be detached therefrom, for example, as a result of being built into the exercise appliance.

According to the motion analysis method according to this application example, it is possible to calculate a rotation angle about the long axis of the shaft of the exercise appliance when the subject holds the exercise appliance, and thus it is possible to generate initial attitude information of the exercise appliance when the subject holds the exercise appliance, by using the rotation angle. Therefore, for example, it is possible to analyze motion of the subject with high accuracy by using the initial attitude information of the exercise appliance, or to prompt the subject to improve the motion by presenting the initial attitude information of the exercise appliance.

According to the motion analysis method of this application example, since initial attitude information of the exercise appliance can be generated by using outputs from the inertial sensor attached to the exercise appliance, it is not necessary to prepare a large-sized measurement tool such as a camera, and a measurement location is not greatly limited.

### APPLICATION EXAMPLE 2

In the motion analysis method according to the application example, in a case where an attitude of the exercise appliance when the shaft is raised vertically to a hit ball target direction is set as a reference attitude, the rotation angle may be a rotation angle about the long axis of the shaft of the exercise appliance in the initial attitude relative to the reference attitude.

According to the motion analysis of this application example, it is possible to generate the initial attitude information of the exercise appliance on the basis of a rotation angle about the long axis of the shaft of the exercise appliance relative to the reference attitude in the initial attitude of the exercise appliance when the subject holds the exercise appliance.

### APPLICATION EXAMPLE 3

In the motion analysis method according to the application example, the inertial sensor may have a plurality of detection axes such as a first detection axis corresponding to the long axis direction of the shaft, a second detection axis corresponding to the hit ball target direction, and a third detection axis corresponding to a downward direction which is orthogonal to the first detection axis and the second detection axis, and, in the rotation angle computation step, the rotation angle may be computed by using an acceleration in a direction of the second detection axis and an acceleration in a direction of the third detection axis, measured by the inertial sensor when the exercise appliance is in the initial attitude.

According to the motion analysis method of this application example, it is possible to relatively easily compute a rotation angle about the long axis of the shaft of the exercise appliance relative to the reference attitude in the initial attitude of the exercise appliance.

### APPLICATION EXAMPLE 4

The motion analysis method according to the application example may further include an inclined angle computation step of computing a combined acceleration of an acceleration in a direction of the first detection axis, the acceleration in the direction of the second detection axis, and the acceleration in the direction of the third detection axis, measured by the inertial sensor when the exercise appliance is in the initial attitude, and an inclined angle of the shaft is computed by using the acceleration in the direction of the first detection axis and the combined acceleration, and, in the initial attitude information generation step, the initial attitude information may be generated by using the inclined angle.

According to the motion analysis method of this application example, it is possible to relatively easily compute an inclined angle about the long axis of the shaft of the exercise appliance in the initial attitude of the exercise appliance. It is possible to generate more specific initial attitude information by using the inclined angle.

### APPLICATION EXAMPLE 5

The motion analysis method according to the application example may further include a motion analysis step of analyzing motion in which the subject has hit a ball with the exercise appliance, by using the initial attitude information and the outputs from the inertial sensor.

According to the motion analysis method of this application example, it is possible to analyze motion of the subject with high accuracy by using the initial attitude information of the exercise appliance.

### APPLICATION EXAMPLE 6

In the motion analysis method according to the application example, in the motion analysis step, a combined value of the outputs from the inertial sensor maybe computed, and the time when the subject has hit the ball with the exercise appliance maybe specified on the basis of the combined value.

The combined value of the outputs from the inertial sensor may be a sum or an average value of outputs in the respective detection axes of the inertial sensor, a square sum or a square root of outputs in the respective detection axes of the inertial sensor, the product of outputs in the respective detection axes of the inertial sensor, or the like.

According to the motion analysis method of this application example, it is possible to relatively easily specify a timing at which the subject has hit the ball on the basis of the combined value of the outputs from the inertial sensor.

### APPLICATION EXAMPLE 7

The motion analysis method according to the application example may further include an advice information generation step of generating advice information regarding the way the subject holds the exercise appliance, by using the initial attitude information.

According to the motion analysis method of this application example, the subject can specifically recognize an address attitude thereof on the basis of the advice information.

### APPLICATION EXAMPLE 8

In the motion analysis method according to the application example, the exercise appliance maybe a golf club.

According to the motion analysis method of this application example, it is possible to analyze motion of the subject with high accuracy by using the initial attitude information of the golf club, or to prompt the subject to improve the motion by presenting the initial attitude information of the golf club.

### APPLICATION EXAMPLE 9

A motion analysis apparatus according to this application example includes a rotation angle computation portion computing a rotation angle about a long axis of a shaft of an exercise appliance when a subject holds the exercise appliance, by using outputs from an inertial sensor attached to the exercise appliance; and an initial attitude information generation portion generating initial attitude information regarding an initial attitude of the exercise appliance by using the rotation angle.

According to the motion analysis apparatus of this application example, for example, it is possible to analyze motion of the subject with high accuracy by using the initial attitude information of the exercise appliance, or to prompt the subject to improve the motion by presenting the initial attitude information of the exercise appliance.

According to the motion analysis apparatus of this application example, since initial attitude information of the exercise appliance can be generated by using outputs from the inertial sensor attached to the exercise appliance, it is not necessary to prepare a large-sized measurement tool such as a camera, and a measurement location is not greatly limited.

### APPLICATION EXAMPLE 10

A motion analysis system according to this application example includes the motion analysis apparatus; and the inertial sensor.

According to the motion analysis system of this application example, for example, it is possible to analyze motion of the subject with high accuracy by using the initial attitude information of the exercise appliance, or to prompt the subject to improve the motion by presenting the initial attitude information of the exercise appliance.

### APPLICATION EXAMPLE 11

A program according to this application example causes a computer to execute a rotation angle computation step of computing a rotation angle about a long axis of a shaft of an exercise appliance when a subject holds the exercise appliance, by using outputs from an inertial sensor attached to the exercise appliance; and an initial attitude information generation step of generating initial attitude information regarding an initial attitude of the exercise appliance by using the rotation angle.

According to the program of this application example, for example, it is possible to analyze motion of the subject with high accuracy by using the initial attitude information of the exercise appliance, or to prompt the subject to improve the motion by presenting the initial attitude information of the exercise appliance.

According to the program of this application example, since initial attitude information of the exercise appliance can be generated by using outputs from the inertial sensor attached to the exercise appliance, it is not necessary to prepare a large-sized measurement tool such as a camera, and a measurement location is not greatly limited.

### BRIEF DESCRIPTION OF DRAWINGS

FIG. 1 is a diagram illustrating a motion analysis system according to the present embodiment.

FIG. 2 is a diagram illustrating an example of a position at which and a direction in which the sensor unit is attached.

FIG. 3 is a diagram illustrating a procedure of actions performed by a subject in the present embodiment.

FIG. 4(A) and FIG. 4(B) are diagrams illustrating examples of initial attitudes of a golf club.

FIG. 5(A) and FIG. 5(B) are respectively sectional views in which the golf clubs and the sensor units in FIG. 4(A) and FIG. 4(B) are cut in a plane perpendicular to a long axis of a shaft.

FIG. 6 is a diagram illustrating a configuration example of a motion analysis system according to the present embodiment.

FIG. 7 is a flowchart illustrating examples of procedures of a motion analysis process in the present embodiment.

FIG. 8 is a diagram illustrating a relationship between acceleration measured by the sensor unit and a rotation angle θ about the long axis of the shaft.

FIG. 9 is a diagram illustrating a relationship between acceleration measured by the sensor unit and an inclined angle ψ of the shaft.

FIG. 10 is a flowchart illustrating examples of procedures of a process of detecting a timing at which the subject hits a ball.

FIG. 11A is a diagram in which three-axis angular velocities during a swing are displayed in a graph, FIG. 11B is a diagram in which a calculated value of a combined value of the three-axis angular velocities is displayed in a graph, and FIG. 11C is a diagram in which a calculated value of a derivative of the combined value of the three-axis angular velocities is displayed in a graph.

FIG. 12 is a flowchart illustrating examples of procedures of a process of computing an attitude of the sensor unit.

### DESCRIPTION OF EMBODIMENT

Hereinafter, preferred embodiments of the invention will be described with reference to the drawings. The embodiments described below are not intended to improperly limit the content of the invention disclosed in the claims. In addition, all constituent elements described below are not essential constituent elements of the invention.

Hereinafter, a motion analysis system (motion analysis apparatus) analyzing a golf swing will be described as an example.

### 1. MOTION ANALYSIS SYSTEM

### [Outline of Motion Analysis System]

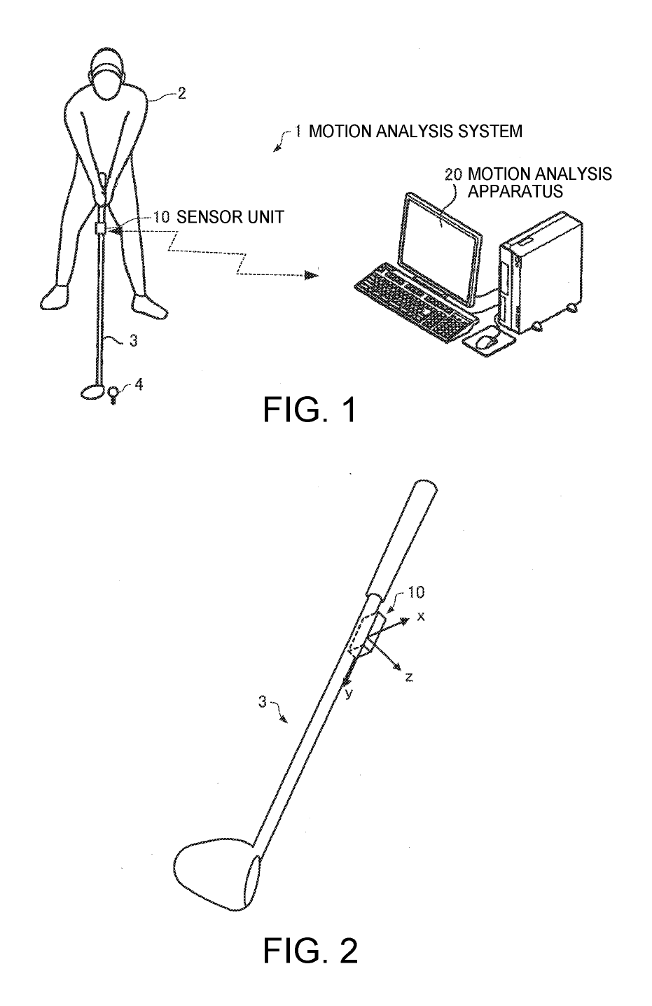

FIG. 1 is a diagram for explaining an outline of a motion analysis system according to the present embodiment. A motion analysis system 1 of the present embodiment is configured to include a sensor unit 10 (an example of an inertial sensor) and a motion analysis apparatus 20.

The sensor unit 10 can measure acceleration generated in each axial direction of three axes and angular velocity generated around each of the three axes, and is attached to at least one of a golf club 3 (an example of an exercise appliance).

In the present embodiment, as illustrated in FIG. 2, the sensor unit 10 is attached to a part of a shaft of the golf club 3 so that one axis of three detection axes (an x axis (an example of a second detection axis), a y axis (an example of a first detection axis), and a z axis (an example of a third detection axis)), for example, the y axis matches a long axis direction of the shaft. Preferably, the sensor unit 10 is attached to a position close to a grip portion to which impact during ball hitting is hardly forward and a centrifugal force is not applied. The shaft is a shaft portion other than a head of the golf club 3 and also includes the grip portion.

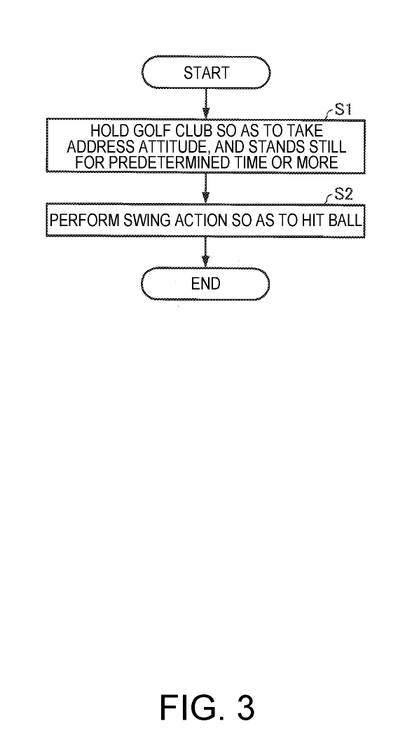

The subject 2 performs a swing action for hitting a golf ball 4 according to predefined procedures. FIG. 3 is a diagram illustrating procedures of actions performed by the subject 2. As illustrated in FIG. 3, first, the subject 2 holds the golf club 3 so as to take an address attitude, and stands still for a predetermined time period or more (for example, for one second or more) (step S1). Next, the subject 2 performs a swing action so as to hit a golf ball 4 (step S2).

While the subject 2 performs the action of hitting the golf ball 4 according to the procedures illustrated in FIG. 3, the sensor unit 10 measures three-axis acceleration and three-axis angular velocity at a predetermined cycle (for example, 1 ms), and sequentially transmits measured data to the motion analysis apparatus 20. The sensor unit 10 may instantly transmit the measured data, and may store the measured data in an internal memory and transmit the measured data at a desired timing such as completion of a swing action of the subject 2. Alternatively, the sensor unit 10 may store the measured data in an attachable/detachable recording medium such as a memory card, and the motion analysis apparatus 20 may read the measured data from the recording medium.

The motion analysis apparatus 20 computes a rotation angle about the long axis of the shaft of the golf club 3 or an inclined angle of the shaft when the subject 2 holds the golf club 3 (at address) by using data measured by the sensor unit 10, and generates initial attitude information of the golf club 3 by using the rotation angle or the inclined angle. The initial attitude information of the golf club 3 may include, for example, some or all of a lie angle (an inclined angle of the shaft of the golf club 3), a face angle (an azimuth angle of the face of the golf club 3), and a loft angle (an inclined angle of the face of the golf club 3) at address of the subject 2.

The motion analysis apparatus 20 analyzes motion in which the subject 2 has hit the ball with the golf club 3, by using the initial attitude information of the golf club 3 and the data measured by the sensor unit 10.

The motion analysis apparatus 20 generates advice information regarding the way the subject 2 holds the golf club (address attitude) by using the initial attitude information of the golf club 3, and presents the advice information to the subject 2 with an image, a sound, vibration, or the like.

Communication between the sensor unit 10 and the motion analysis apparatus 20 may be wireless communication, and may be wired communication.

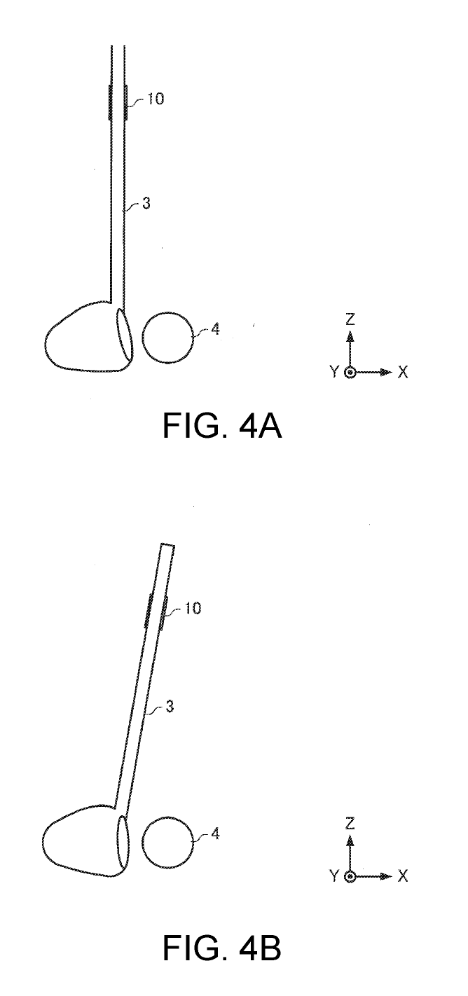

FIG. 4(A) and FIG. 4(B) are diagrams illustrating examples of initial attitudes of the golf club 3. In the present embodiment, an XYZ coordinate system (world coordinate system) is defined which has a target line indicating a target direction of a hit ball as an X axis, an axis on a horizontal plane which is perpendicular to the X axis as Y axis, and a vertically upward direction (a direction opposite to the gravitational direction) as a Z axis. FIG. 4(A) and FIG. 4(B) illustrate the X axis, the Y axis, and the Z axis. The target line indicates, for example, a direction in which a ball flies straight. FIG. 4(A) and FIG. 4(B) are diagrams in which the golf club 3 and the golf ball 4 are projected onto an XZ plane. FIG. 4(A) is a diagram illustrating a case where the subject 2 is addressed so that the long axis of the shaft of the golf club 3 is vertical to the target direction of a hit ball. On the other hand, FIG. 4(B) is a diagram illustrating a case where the subject 2 is addressed so that the grip of the golf club 3 is located further toward the hit ball direction side than the head, that is, the subject 2 takes a hand-first attitude by raising a loft of the golf club 3.

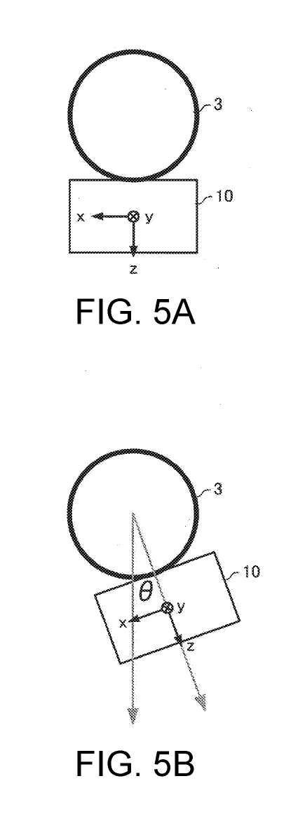

FIG. 5(A) and FIG. 5(B) are respectively sectional views in which the golf club 3 and the sensor unit 10 in FIG. 4(A) and FIG. 4(B) are cut in a plane perpendicular to the long axis of the shaft. In a case where the subject takes the hand-first attitude as in FIG. 4(B), the golf club 3 is in a state in which the golf club is rotated about the long axis of the shaft by an angle θ corresponding to the hand-first with respect to the attitude as in FIG. 4(A).

An inclination of the golf club 3 relative to the gravitational direction of the shaft can be specified by using data measured by an inertial sensor, but an angle in a direction perpendicular to the gravitational acceleration, that is, an azimuth angle cannot be specified. Thus, in a motion analysis system of the related art employing the inertial sensor, an axis obtained by projecting the x axis of the sensor unit 10 onto a horizontal plane is used as an X axis (azimuth angle of 0°) on the basis of the x axis of the sensor unit 10 being directed in a target direction of a hit ball at address of the subject 2. In this case, if the subject 2 takes an address attitude such as a hand-first attitude as illustrated in FIG. 4(B), the x axis of the sensor unit 10 is not directed in the target direction of a hit ball, and thus accuracy of swing analysis may deteriorate.

In the motion analysis system 1 of the present embodiment, as illustrated in FIG. 2, the sensor unit 10 is attached to the golf club 3 so that the y axis matches the long axis direction of the shaft of the golf club 3. An attitude of the golf club 3 when the subject 2 takes an address attitude as illustrated in FIG. 4(A), that is, an attitude of the golf club 3 when the shaft is raised vertically to the target direction of a hit ball is defined as a reference attitude. Therefore, when an initial attitude of the golf club 3 is the reference attitude, a rotation angle about the long axis of the shaft in the initial attitude relative to the reference attitude of the golf club 3 is 0°. In the sensor unit 10, since the y axis is directed in the long axis direction of the shaft, the x axis is directed in a target direction of a hit ball, and the z axis is directed in the downward direction perpendicular to the x axis and the y axis, the x axis is horizontal. Thus, a measured value of the gravitational acceleration in the x axis direction is zero. On the other hand, in a case where the subject 2 takes an address attitude such as a hand-first attitude as illustrated in FIG. 4(B), a rotation angle of the golf club 3 about the long axis of the shaft in the initial attitude relative to the reference attitude is generated as θ as illustrated in FIG. 5(B), and thus a gravitational acceleration component is measured in the x axis direction. Therefore, in the motion analysis system 1 of the present embodiment, the motion analysis apparatus 20 computes the rotation angle θ by using data (measured data of the gravitational acceleration) measured by the sensor unit 10 at address of the subject 2, and specifies an initial attitude (an attitude at address) of the golf club 3. The motion analysis apparatus 20 can perform swing analysis with high accuracy by accurately specifying an initial attitude of the golf club 3.

### [Configuration of Motion Analysis System]

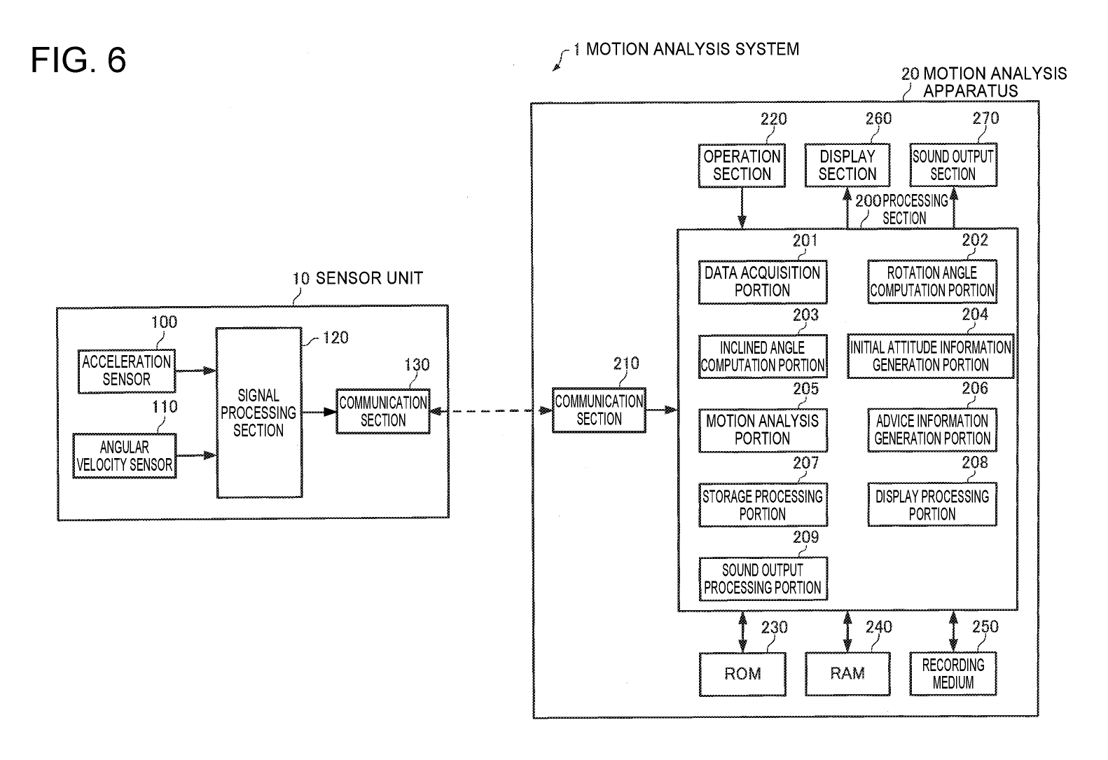

FIG. 6 is a diagram illustrating configuration examples of the sensor unit 10 and the motion analysis apparatus 20. As illustrated in FIG. 6, in the present embodiment, the sensor unit 10 is configured to include an acceleration sensor 100, an angular velocity sensor 110, a signal processing section 120, and a communication section 130.

The acceleration sensor 100 measures respective accelerations in three axial directions which intersect (ideally, orthogonal to) each other, and outputs digital signals (acceleration data) corresponding to magnitudes and directions of the measured three-axis accelerations.

The angular velocity sensor 110 measures respective angular velocities in three axial directions which intersect (ideally, orthogonal to) each other, and outputs digital signals (angular velocity data) corresponding to magnitudes and directions of the measured three-axis angular velocities.

The signal processing section 120 receives the acceleration data and the angular velocity data from the acceleration sensor 100 and the angular velocity sensor 110, respectively, adds time information thereto, stores the data in a storage portion (not illustrated), adds time information to the stored measured data (the acceleration data and the angular velocity data) so as to generate packet data conforming to a communication format, and outputs the packet data to the communication section 130.

Ideally, the acceleration sensor 100 and the angular velocity sensor 110 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 120 performs a process of converting the acceleration data and the angular velocity data into data in the xyz coordinate system by using a correction parameter which is calculated in advance so as to the installation angle errors.

The signal processing section 120 performs a process of correcting the temperatures of the acceleration sensor 100 and the angular velocity sensor 110. The acceleration sensor 100 and the angular velocity sensor 110 may have a temperature correction function.

The acceleration sensor 100 and the angular velocity sensor 110 may output analog signals, and, in this case, the signal processing section 120 may A/D convert an output signal from the acceleration sensor 100 and an output signal from the angular velocity sensor 110 so as to generate measured data (acceleration data and angular velocity data), and may generate communication packet data by using the data.

The communication section 130 performs a process of transmitting packet data received from the signal processing section 120 to the motion analysis apparatus 20, or a process of receiving a control command from the motion analysis apparatus 20 and sending the control command to the signal processing section 120. The signal processing section 120 performs various processes corresponding to control commands.

The motion analysis apparatus 20 is configured to include a processing section 200, a communication section 210, an operation section 220, a ROM 230, a RAM 240, a recording medium 250, a display section 260, and a sound output section 270, and may be, for example, a personal computer (PC) or a portable apparatus such as a smart phone.

The communication section 210 performs a process receiving packet data transmitted from the sensor unit 10 and sending the packet data to the processing section 200, or a process of transmitting a control command from the processing section 200 to the sensor unit 10.

The operation section 220 performs a process of acquiring operation data from a user and sending the operation data to the processing section 200. The operation section 220 may be, for example, a touch panel type display, a button, a key, or a microphone.

The ROM 230 stores a program for the processing section 200 performing various calculation processes or a control process, or various programs or data for realizing application functions.

The RAM 240 is used as a work area of the processing section 200, and is a storage section which temporarily stores a program or data read from the ROM 230, data which is input from the operation section 220, results of calculation executed by the processing section 200 according to various programs, and the like.

The recording medium 250 is a nonvolatile storage section storing data which is preserved for a long period of time among data items generated through processing of the processing section 200. The recording medium 250 may store a program for the processing section 200 performing various calculation processes, or various program or data for realizing application functions.

In the present embodiment, the ROM 230, the RAM 240, or the recording medium 250 stores specification information regarding the golf club 3 (information regarding a length of the shaft, a position of the centroid thereof, a lie angle, a loft angle, and the like), an installation position (a distance from the head or the grip end of the golf club 3) regarding the sensor unit 10, and information regarding a length of the arm or a position of the centroid of the subject 2, and this information is used by the processing section 200.

The display section 260 displays a processing result in the processing section 200 as text, a graph, a table, animation, and other images. The display section 260 may be, for example, a CRT, an LCD, a touch panel type display, and a head mounted display (HMD). A single touch panel type display may realize functions of the operation section 220 and the display section 260.

The sound output section 270 displays a processing result in the processing section 200 as a sound such as a voice or a buzzer sound. The sound output section 270 may be, for example, a speaker or a buzzer.

The processing section 200 performs a process of transmitting a control command to the sensor unit 10 according to a program stored in the ROM 230 or the recording medium 250, or a program which is received from a server via a network and is stored in the RAM 240 or the recording medium 250, various calculation processes on data which is received from the sensor unit 10 via the communication section 210, and various control processes. Particularly, by executing the program, in the present embodiment, the processing section 200 functions as a data acquisition portion 201, a rotation angle computation portion 202, an inclined angle computation portion 203, an initial attitude information generation portion 204, a motion analysis portion 205, an advice information generation portion 206, a storage processing portion 207, a display processing portion 208, and a sound output processing portion 209.

The data acquisition portion 201 performs a process of receiving packet data which is received from the sensor unit 10 by the communication section 210, acquiring time information and measured data from the received packet data, and sending the time information and the measured data to the storage processing portion 207.

The storage processing portion 207 performs a process of receiving the time information and the measured data from the data acquisition portion 201 and storing the time information and the measured data in the RAM 240 in correlation with each other.

The rotation angle computation portion 202 performs a process of computing a rotation angle θ about the long axis of the shaft relative to the reference attitude in an initial attitude of the golf club 3 by using the measured data (acceleration data) output from the sensor unit 10. In the present embodiment, the rotation angle computation portion 202 computes the rotation angle θ by using an acceleration in the x axis direction and an acceleration in the z axis direction, measured by the sensor unit 10 when the golf club 3 is in an initial attitude.

The inclined angle computation portion 203 performs a process of computing an inclined angle ψ relative to the gravitational direction in an initial attitude of the golf club 3 by using the measured data (acceleration data) output from the sensor unit 10. In the present embodiment, the inclined angle computation portion 203 computes a combined acceleration of an acceleration in the x axis direction, an acceleration in the z axis direction, and an acceleration in the z axis direction, measured by the sensor unit 10 when the golf club 3 is in an initial attitude, and computes the inclined angle ψ by using the acceleration in the y axis direction and the combined acceleration.

The initial attitude information generation portion 204 performs a process of generating initial attitude information of the golf club 3 by using some or all of the rotation angle θ, the inclined angle ψ, and a lie angle, a face angle, and a loft angle as the specifications of the golf club 3. The initial attitude information of the golf club 3 may include, for example, some or all of a lie angle, a face angle, and a loft angle at address of the subject 2.

The motion analysis portion 205 performs a process of analyzing a swinging motion of the subject 2 by using the initial attitude information of the golf club 3, the measured data (the acceleration data and the angular velocity data) output from the sensor unit 10, so as to generate motion analysis information.

Specifically, the motion analysis portion 205 computes an offset amount by using the measured data during stoppage action of the subject 2 (at address), stored in the RAM 240. Next, the motion analysis portion 205 subtracts the offset amount from the measured data from the measured data stored in the RAM 240 so as to perform bias correction, and computes a position and an attitude of the sensor unit 10 during a swing action of the subject 2 (during action in step S2 in FIG. 3) by using the bias-corrected measured data. The motion analysis portion 205 may set an initial position of the sensor unit 10 to the origin (0,0,0) of the XYZ coordinate system, and may integrate the acceleration data so as to compute a position change from the initial position of the sensor unit 10 in a time series. The motion analysis portion 205 may perform rotation calculation using the angular velocity data with an attitude of the sensor unit 10 in the initial attitude of the golf club 3 as an initial attitude, so as to compute an attitude change from the initial attitude of the sensor unit 10 in a time series. An attitude of the sensor unit 10 may be expressed by, for example, rotation angles (a roll angle, a pitch angle, and a yaw angle) about the X axis, the Y axis, and the Z axis, Euler angles, or a quaternion.

The signal processing section 120 of the sensor unit 10 may calculate an offset amount of measured data so as to perform bias correction on the measured data, and the acceleration sensor 100 and the angular velocity sensor 110 may have a bias correction function. In this case, it is not necessary for the motion analysis portion 205 to perform bias correction on the measured data.

The motion analysis portion 205 defines a motion analysis model (double pendulum model) in which a length and a position of the centroid of the shaft of the golf club 3, an installation position of the sensor unit 10, features (rigid body) of the golf club 3, or human features (a joint bending direction, and the like) are taken into consideration, and calculates a trajectory of the motion analysis model by using information regarding the position and the attitude of the sensor unit 10, the length and the position of the centroid of the shaft of the golf club 3, the installation position of the sensor unit 10, and features (a joint bending direction, and the like) of the subject 2.

The motion analysis portion 205 detects a timing (time point) at which the subject 2 has hit the ball in a period of the swing action by using the time information and the measured data stored in the RAM 240. In the present embodiment, the motion analysis portion 205 computes a combined value of the measured data (the acceleration data or the angular velocity data) output from the sensor unit 10, and specifies the timing (time point) at which the subject 2 has hit the ball on the basis of the combined value. The motion analysis portion 205 computes some or all of a lie angle, a face angle, and a loft angle during ball hitting of the subject 2 by using some or all of information pieces regarding a position and an attitude of the motion analysis model during ball hitting (during impact), and a lie angle, a face angle, and a loft angle as the specifications of the golf club 3, and generates the second attitude information including such information, and generates attitude information (attitude information of the golf club during ball hitting) including such information.

The motion analysis portion 205 generates motion analysis information by using a trajectory of the motion analysis model, the attitude information of the golf club 3 during ball hitting, or the like. The motion analysis information is, for example, information regarding a trajectory of the swing (a trajectory of the head of the golf club 3), rhythm of the swing from a backswing to follow-through, a head speed, an incidence angle (club path) or a face angle during hitting of a ball, shaft rotation (a change amount of a face angle during swing), a V zone, and a deceleration rate of the golf club 3, or information regarding a variation in these information pieces in a case where the subject 2 performs a plurality of swings.

The advice information generation portion 206 performs a process of generating advice information regarding the way the subject 2 holds the golf club (address attitude) by using the initial attitude information of the golf club 3 or the motion analysis information. The advice information may be information regarding, for example, whether or not a hand-first attitude is taken, to what extent a hand-first attitude is taken, a method for taking (not taking) a hand-first attitude, and an ideal address attitude.

Since an ideal address attitude of the subject 2 differs depending on the kind of golf club 3, physical features of the subject 2, a swing habit, or the like, the advice information generation portion 206 may perform predetermined calculation in which features of the golf club 3, information regarding a trajectory of the motion analysis model, or the like is also taken into consideration, and may generate the advice information.

The storage processing portion 207 performs read/write processes of various programs or various data for the ROM 230, the RAM 240, and the recording medium 250. The storage processing portion 207 performs not only the process of storing the time information and the measured data received from the data acquisition portion 201 in the RAM 240 in correlation with each other, but also a process of storing the initial attitude information, the motion analysis information, the advice information, and the like in the RAM 240, or a process of storing the information in the recording medium 250 in a case where the information is desired to be kept as a record.

The display processing portion 208 performs a process of displaying various images (including text, symbols, and the like) on the display section 260. For example, the display processing portion 208 performs a process of reading the motion analysis information or the advice information stored in the RAM 240 or the recording medium 250 automatically or when a predetermined input operation is input after a swing action of the subject 2 is completed, and displaying an motion analysis image or an advice image on the display section 260. The display processing portion 208 may read the first position information, the second position information, the position difference information, and the like stored in the RAM 240 or the recording medium 250, and may display various images on the display section 260. Alternatively, a display section may be provided in the sensor unit 10, and the display processing portion 208 may transmit an advice image or the like to the sensor unit 10 via the communication section 210, and various images may be displayed on the display section of the sensor unit 10.

The sound output processing portion 209 performs a process of outputting various sounds (including voices, buzzer sounds, and the like) from the sound output section 270. For example, the sound output processing portion 209 may read the motion analysis information or the advice information stored in the RAM 240 or the recording medium 250 automatically or when a predetermined input operation is input after a swing action of the subject 2 is completed, and may output a motion analysis sound or an advice sound from the sound output section 270. The sound output processing portion 209 may read the initial attitude information, and the like stored in the RAM 240 or the recording medium 250, and may output various sounds from the sound output section 270. Alternatively, a sound output section may be provided in the sensor unit 10, and the sound output processing portion 209 may transmit an advice sound or the like to the sensor unit 10 via the communication section 210, and may output various sounds from the sound output section of the sensor unit 10.

A vibration mechanism may be provided in the motion analysis apparatus 20 or the sensor unit 10, and various information may be converted into vibration information by the vibration mechanism so as to be presented to the subject 2.

### [Motion Analysis Process]

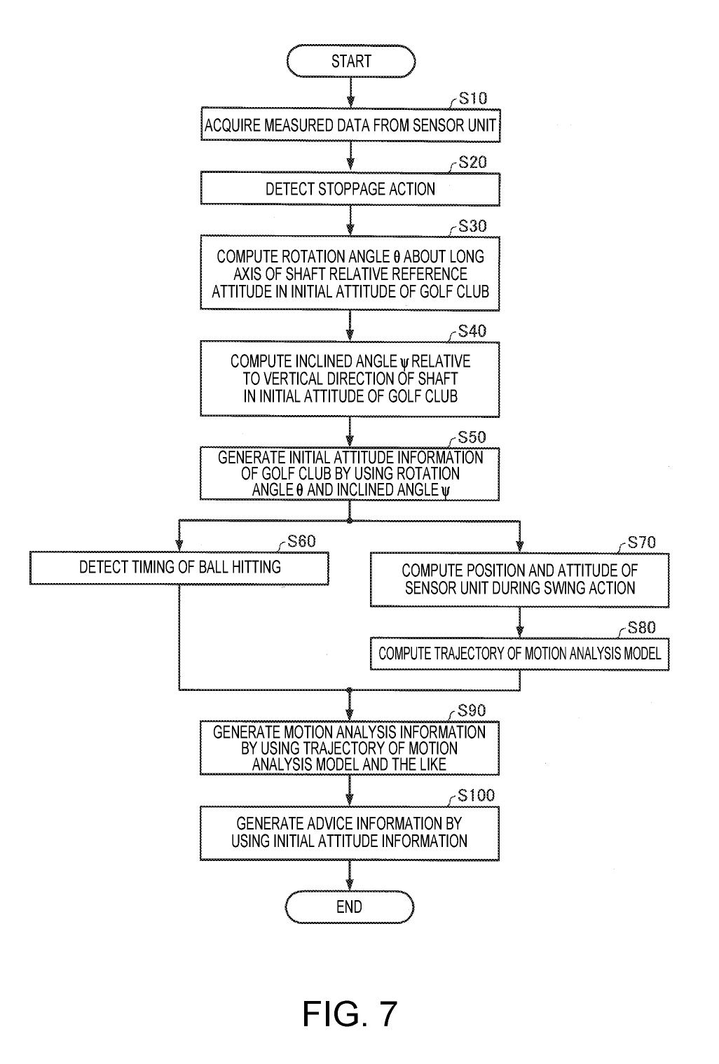

FIG. 7 is a flowchart illustrating examples of procedures of a motion analysis process performed by the processing section 200 in the present embodiment.

As illustrated in FIG. 7, first, the processing section 200 acquires measured data from the sensor unit 10 (step S10). If initial measured data in a swing action (also including a stoppage action) of the subject 2 in step S10, the processing section 200 may perform processes in step S20 and the subsequent steps in real time, and may perform the processes in step S20 and the subsequent steps after acquiring some or all of a series of measured data in the swing action of the subject 2 from the sensor unit 10.

Next, the processing section 200 detects a stoppage action of the subject 2 (address action) (the action in step S1 in FIG. 4) by using the measured data acquired from the sensor unit 10 (step S20). In a case where the process is performed in real time, when the stoppage action (address action) is detected, the processing section 200 may output, for example, a predetermined image or sound, or may turn on an LED provided in the sensor unit 10, so as to notify the subject 2 of detection of the stoppage action, and the subject 2 may start a swing after checking the notification.

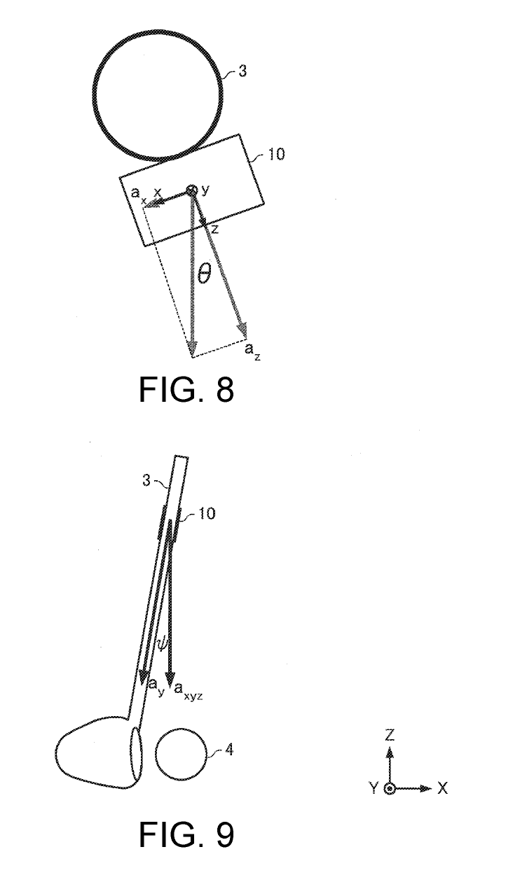

Next, the processing section 200 computes the rotation angle θ about the long axis of the shaft relative to the reference attitude in an initial attitude of the golf club 3 by using the measured data (measured data during a stoppage action (address action) of the subject 2) acquired from the sensor unit 10 (step S30). FIG. 8 is a diagram illustrating a relationship between accelerations measured by the sensor unit 10 and the rotation angle θ. As illustrated in FIG. 8, an acceleration aₓ in the x axis direction and an acceleration a_{y} in the y axis direction, measured by the sensor unit 10 at address, and the rotation angle θ have a relationship of the following Equation (1). Therefore, the processing section 200 can compute the rotation angle θ of the golf club 3 at address by using Equation (1).

$$\begin{matrix}[ Expression 1 ] & \\ θ = {tan}^{- 1} ( \frac{{a}_{x}}{{a}_{z}} ) & ( 1 )\end{matrix}$$

Next, the processing section 200 computes inclined angle ψ relative to the vertical direction of the shaft in the initial attitude of the golf club 3 by using the measured data (measured data during a stoppage action (address action) of the subject 2) acquired from the sensor unit 10 (step S40). FIG. 9 is a diagram illustrating a relationship between accelerations measured by the sensor unit 10 and the inclined angle ψ. As illustrated in FIG. 9, a combined acceleration a_{xyz} of an acceleration aₓ in the x axis direction, an acceleration a_{y} in the y axis direction, an acceleration a_{z} in the z axis direction, measured by the sensor unit 10 at address, is the gravitational acceleration of 1 G, and the acceleration a_{y} in the y axis direction, the combined acceleration a_{xyz}, and the inclined angle ψ of the golf club 3 relative to the vertical direction have a relationship of the following Equation (2). Therefore, the processing section 200 can compute the inclined angle ψ of the golf club 3 at address by using Equation (2).

$$\begin{matrix}[ Expression 2 ] & \\ ϕ = {cos}^{- 1} ( \frac{{a}_{xyz}}{{a}_{y}} ) & ( 2 )\end{matrix}$$

Next, the processing section 200 computes a lie angle, a face angle, a loft angle, and the like at address of the subject 2 by using the rotation angle θ, the inclined angle ψ, and the information regarding a lie angle, a face angle, a loft angle, and the like as the specification of the golf club 3, so as to generate initial attitude information of the golf club 3 (step S50).

Next, the processing section 200 detects a timing at which the subject 2 has hit the ball by using the measured data acquired from the sensor unit 10 (step S60).

The processing section 200 performs a process (step S70) of computing a position and an attitude of the sensor unit 10 during swing action of the subject 2, and a process (step S80) of computing a trajectory of the motion analysis model on the basis of changes in the position and the attitude of the sensor unit 10, in parallel to the process in step S60. For example, the processing section 200 sets an initial position of the sensor unit 10 to the origin of the XYZ coordinate system, and specifies a direction of the gravitational acceleration on the basis of the acceleration data measured by the sensor unit 10 so as to compute an initial attitude in the XYZ coordinate system. Thereafter, the processing section 200 computes a position by integrating the acceleration data measured by the sensor unit 10, and computes an attitude by performing rotation calculation by using the angular velocity data measured by the sensor unit 10. The processing section 200 computes a trajectory of the motion analysis model by using the position and the attitude of the sensor unit 10, specification information of the golf club 3, an installation position of the sensor unit 10, feature information of the subject 2, and the like.

Next, the processing section 200 computes an attitude or the like (a lie angle, a face angle, a loft angle, or the like) of the golf club 3 during ball hitting of the subject 2 by using the trajectory of the motion analysis model or the specification information of the golf club, so as to generate motion analysis information (step S90).

Finally, the processing section 200 generates advice information regarding an address attitude by using the initial attitude information or the motion analysis information (step S100).

In the flowchart of FIG. 7, order of the respective steps may be changed as appropriate within an allowable range.

### [Impact Detection Process]

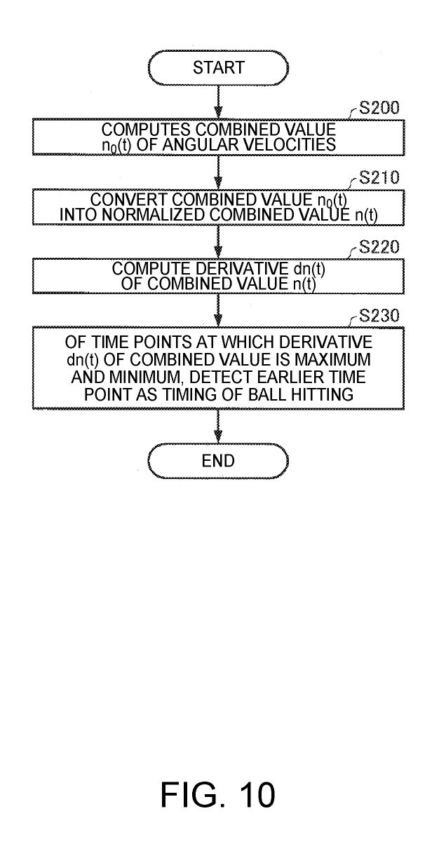

FIG. 10 is a flowchart illustrating examples of procedures of a process (the process in step S60 in FIG. 7) of detecting a timing at which the subject 2 has hit the ball.

As illustrated in FIG. 10, first, the processing section 200 calculates a combined value n₀(t) of angular velocities at each time point t by using the acquired angular velocity data (acceleration data for each time point t) (step S200). For example, if the acceleration data items at the time point t are respectively indicated by x(t), y(t), and z(t), the combined value n₀(t) of the angular velocities is calculated according to the following Equation (3).

[Expression 3]

n₀(t)=\sqrt{x(t)²+y(t)²+z(t)²} (3)

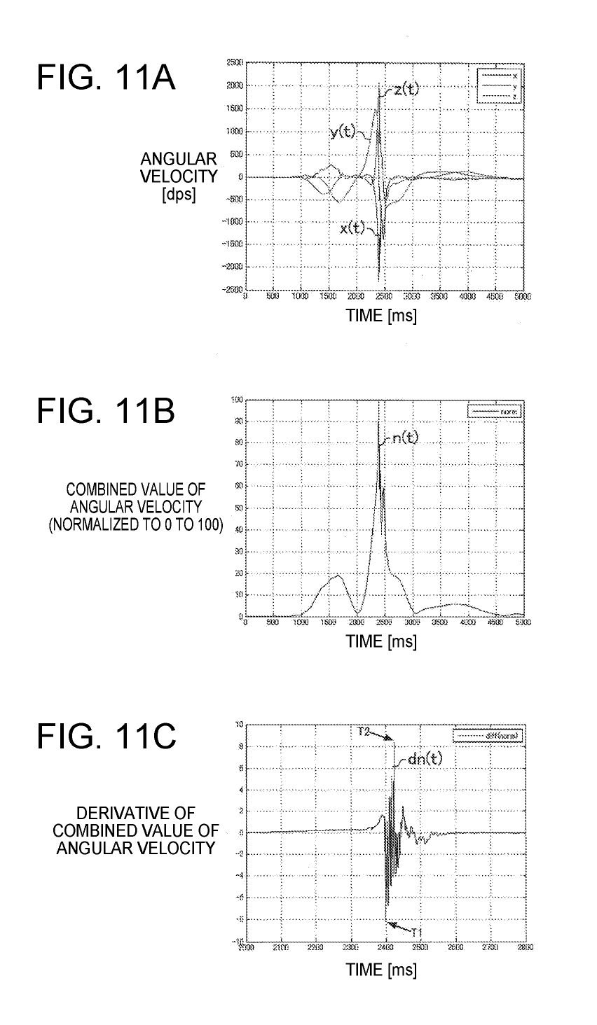

FIG. 11A illustrates examples of three-axis angular velocity data items x(t), y(t) and z(t) obtained when the subject 2 hits the golf ball 4 by performing a swing. In FIG. 11A, a transverse axis expresses time (msec), and a longitudinal axis expresses angular velocity (dps).

Next, the processing section 200 converts the combined value n₀(t) of the angular velocities at each time point t into a combined value n(t) which is normalized (scale-conversion) within a predetermined range (step S210). For example, if the maximum value of the combined value of the angular velocities in an acquisition period of measured data is max(n₀), the combined value n₀(t) of the angular velocities is converted into the combined value n(t) which is normalized within a range of 0 to 100 according to the following Equation (4).

$$\begin{matrix}[ Expression 4 ] & \\ n ( t ) = \frac{100 {n}_{0} ( t )}{max ( {n}_{0} )} & ( 4 )\end{matrix}$$

FIG. 11B is a diagram in which the combined value n₀(t) of the three-axis angular velocities is calculated according to Equation (2) by using the three-axis angular velocity data items x(t), y(t) and z(t) in FIG. 11A, and then the combined value n(t) normalized to 0 to 100 according to Equation (3) is displayed in a graph. In FIG. 11B, a transverse axis expresses time (msec), and a longitudinal axis expresses a norm of the angular velocity.

Next, the processing section 200 calculates a derivative dn(t) of the normalized combined value n(t) at each time point t (step S220). For example, if a cycle for measuring three-axis angular velocity data items is indicated by At, the derivative (difference) dn(t) of the combined value of the angular velocities at the time point t is calculated by using the following Equation (5).

[Expression 5]

dn(t)=n(t)−n(t−Δt) (5)

FIG. 11C is a diagram in which the derivative dn(t) is calculated according to Equation (4) on the basis of the combined value n(t) of the three-axis angular velocities in FIG. 11B, and is displayed in a graph. In FIG. 11C, a transverse axis expresses time (msec), and a longitudinal axis expresses a derivative value of the combined value of the three-axis angular velocities. In FIGS. 11A and 11B, the transverse axis is displayed at 0 seconds to 5 seconds, but, in FIG. 11C, the transverse axis is display at 2 seconds to 2.8 seconds so that changes in the derivative value before and after ball hitting can be understood.

Finally, of time points at which a value of the derivative dn(t) of the combined value becomes the maximum and the minimum the processing section 200, the processing section 200 detects the earlier time point as a ball hitting timing (step S230). It is considered that a swing speed is the maximum at the moment of hitting a ball in a typical golf swing. In addition, since it is considered that a value of the combined value of the angular velocities also changes according to a swing speed, a timing at which a derivative value of the combined value of the angular velocities is the maximum or the minimum (that is, a timing at which the derivative value of the combined value of the angular velocities is a positive maximum value or a negative minimum value) in a series of swing actions can be captured as a timing of ball hitting (impact). Since the golf club 3 vibrates due to ball hitting, a timing at which a derivative value of the combined value of the angular velocities is the maximum and a timing at which a derivative value of the combined value of the angular velocities is the minimum may occur in pairs, and, of the two timings, the earlier timing may be the moment of ball hitting. Therefore, for example, in the graph of FIG. 11C, of T1 and T2, T1 is detected as a timing of ball hitting.

In a case where the subject 2 performs a swing action, a series of motions is expected in which the subject 2 stops the golf club at the top position, performs a down swing, hits the ball, and performs follow-through. Therefore, according to the flowchart of FIG. 10, the processing section 200 may detect candidates of timings at which the subject 2 has hit the ball, determine whether or not measured data before and after the detected timing matches the motions, fix the detected timing as a timing at which the subject 2 has hit the ball if the data matches the motions, and detect the next candidate if the data does not match the motions.

In the flowchart of FIG. 10, the processing section 200 detects a timing of ball hitting by using the three-axis angular velocity data, but can also detect a timing of ball hitting in the same manner by using three-axis acceleration data.

### [Attitude Computation Process of Sensor Unit]

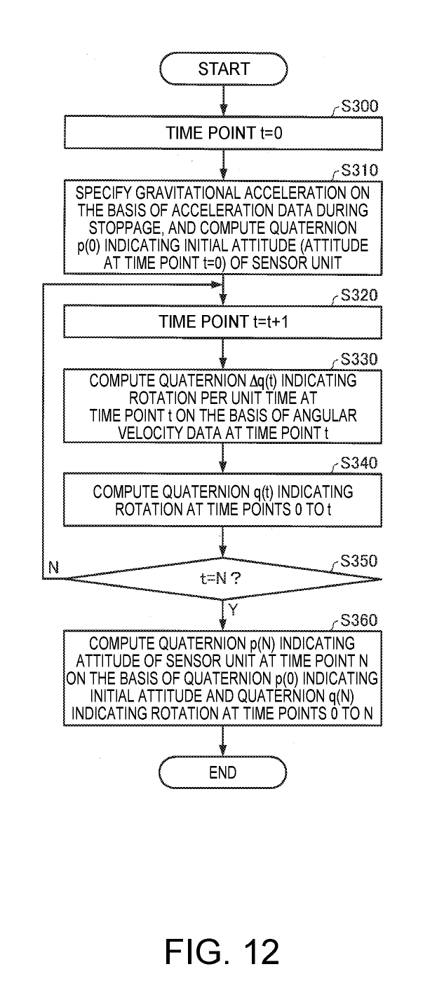

FIG. 12 is a flowchart illustrating examples of procedures of a process (the process in step S70 in FIG. 7) of computing an attitude (an initial attitude and an attitude at a time point N) of the sensor unit 10.

As illustrated in FIG. 12, first, at a time point t=0 (step S300), the processing section 200 specifies a direction of the gravitational acceleration on the basis of three-axis acceleration data during stoppage, and calculates a quaternion p(0) indicating an initial attitude (an attitude at the time point t=0) of the sensor unit 10 (step S310).

For example, if the initial attitude is expressed by a vector (X₀, Y₀, Z₀) in any XYZ coordinate system, the quaternion p(0) for the initial attitude is expressed by the following Equation (6).

[Expression 6]

p(0)=(0, X₀, Y₀, Z₀) (6)

A quaternion q indicating rotation is expressed by the following Equation (7).

[Expression 7]

q=(w, x, y, z) (7)

In Equation (7), if a rotation angle of target rotation is indicated by φ, and a unit vector of a rotation axis is indicated by (rₓ,r_{y},r_{z}), w, x, y, and z are expressed as in Equation (8).

$$\begin{matrix}[ Expression 8 ] & \\ w = cos \frac{φ}{2} , x = {r}_{x} \cdot sin \frac{φ}{2} , y = {r}_{y} \cdot sin \frac{φ}{2} , z = {r}_{z} \cdot sin \frac{φ}{2} & ( 8 )\end{matrix}$$

Since the sensor unit 10 is stopped at the time point t=0, a quaternion q(0) indicating rotation at the time point t=0 with φ=0 is expressed as in the following Equation (9) on the basis of Equation (7) obtained by assigning φ=0 to Equation (8).

[Expression 9]

q(0)=(1,0,0,0) (9)

Next, the processing section 200 updates the time point t to t+1 (step S320), and computes a quaternion Δq(t) indicating rotation per unit time at the time point t on the basis of three-axis angular velocity data at the time point t (step S330).

For example, if the three-axis angular velocity data at the time point t is indicated by ω(t)=(ωₓ(t),ω_{y}(t),ω_{z}(t)), the magnitude |ω(t)| of the angular velocity per sample measured at the time point t is computed by using the following Equation (10).

[Expression 10]

|ω(t)|=\sqrt{ωₓ(t)²+ω_{y}(t)²+ω_{z}(t)²} (10)

The magnitude |ω(t)| of the angular velocity indicates a rotation angle per unit time, and thus a quaternion Δq(t+1) indicating rotation per unit time at the time point t is computed by using the following Equation (11).

$$\begin{matrix} [ Expression 11 ] & \\ Δ q ( t ) = ( cos \frac{\vert ω ( t ) \vert}{2} , \frac{{ω}_{x} ( t )}{\vert ω ( t ) \vert} sin \frac{\vert ω ( t ) \vert}{2} , \frac{{ω}_{y} ( t )}{\vert ω ( t ) \vert} sin \frac{\vert ω ( t ) \vert}{2} , \frac{{ω}_{z} ( t )}{\vert ω ( t ) \vert} sin \frac{\vert ω ( t ) \vert}{2} ) & ( 11 )\end{matrix}$$

Here, since t=1, the processing section 200 computes Δq(1) according to Equation (11) by using three-axis angular velocity data ω(1)=(ωₓ(1),ω_{y}(1),ω_{z}(1)) at the time point t=1.

Next, the processing section 200 computes a quaternion q(t) indicating rotation at time points 0 to t (step S340). The quaternion q(t) is computed according to the following Equation (12).

[Expression 12]

q(t)=q(t−1)·Δq(t) (12)

Here, since t=1, the processing section 200 computes q(1) according to Equation (12) on the basis of q(0) in Equation (9) and Δq(1) computed in step S330.

Next, the processing section 200 repeatedly performs the processes in steps S320 to S340 until t becomes N, and, at the time point t=N (Y in step S350), computes a quaternion p(N) indicating an attitude at the time point N according to the following Equation (13) on the basis of the quaternion p(0) indicating the initial attitude computed in step S310 and the quaternion q(N) indicating the rotation at the time points t=0 to N computed in the previous step S340 (step S360), and then finishes the process.

[Expression 13]

p(N)=q(N)·p(0)·q*(N) (13)

In Equation (13), q*(N) is a conjugate quaternion of q(N). Such p(N) is expressed as in Equation (14), and an attitude of the sensor unit 10 at the time point N is vectorially expressed by (X_{N}, Y_{N}, Z_{N}) in the XYZ coordinate system.

[Expression 14]

p(N)=(0,X_{N},Y_{N},Z_{N}) (14)

The processing section 200 computes an attitude of the sensor unit 10 during ball hitting with the time point at which the subject 2 has hit as the time point N.

As described above, in the motion analysis system 1 of the invention, the sensor unit 10 is attached to the golf club 3 so that the y axis thereof matches the long axis direction of the shaft of the golf club 3, and an attitude of the golf club 3 when the shaft is raised vertically to the target direction of a hit ball is defined as a reference attitude of the sensor unit 10. The motion analysis apparatus 20 can accurately specify an initial attitude of the golf club 3 by computing a rotation angle θ about the long axis of the shaft relative to the reference attitude in an initial attitude of the golf club 3 by using measured data (measured data of the gravitational acceleration) from the sensor unit 10 at address of the subject 2. Therefore, according to the motion analysis system 1 or the motion analysis apparatus 20 of the present embodiment, it is possible to perform swing analysis on the basis of the accurately specified initial attitude of the golf club 3.

According to the motion analysis system 1 or the motion analysis apparatus 20 of the present embodiment, since advice information regarding an address attitude of the subject 2 is generated and is presented on the basis of the accurately specified initial attitude of the golf club 3, the subject 2 can specifically recognize an address attitude thereof. Consequently, it is possible to prompt the subject 2 to improve a golf swing.

According to the motion analysis system 1 or the motion analysis apparatus 20 of the present embodiment, since initial attitude information, advice information, motion analysis information, and the like can be generated by using measured data from the sensor unit 10 attached to the golf club 3, it is not necessary to prepare a large-sized measurement tool such as a camera, and a measurement location is not greatly limited.

### 2. MODIFICATION EXAMPLES

The invention is not limited to the present embodiment, and may be variously modified within the scope of the spirit of the invention.

For example, a timing (impact) at which the subject 2 has hit a ball is detected by using the square root of the square sum as shown in Equation (3) as a combined value of three-axis angular velocities measured by the sensor unit, but, as a combined value of three-axis angular velocities, for example, a square sum of three-axis angular velocities, a sum or an average of three-axis angular velocities, or the product of three-axis angular velocities may be used. Instead of a combined value of three-axis angular velocities, a combined value of three-axis accelerations such as a square sum or a square root of three-axis accelerations, a sum or an average value of three-axis accelerations, or the product of three-axis accelerations may be used.

In the above-described respective embodiment, the motion analysis system (motion analysis apparatus) analyzing a golf swing has been exemplified, but the invention is applicable to a motion analysis system (motion analysis apparatus) analyzing a swing in various sports such as tennis or baseball.

In the above-described embodiment, the motion analysis apparatus 20 computes a trajectory of the motion analysis model by using measured data from a single sensor unit 10, but, a plurality of sensor units 10 may be attached to the golf club 3 or the subject 2, and the motion analysis apparatus 20 may compute a trajectory of the motion analysis model by using measured data from the plurality of sensor units 10.

In the above-described embodiment, the sensor unit 10 and the motion analysis apparatus 20 are provided separately from each other, but may be integrated into a motion analysis apparatus which can be attached to an exercise appliance or a subject.

The above-described embodiment and respective modification examples are only examples, and the invention is not limited thereto. For example, the embodiment and the respective modification examples may be combined with each other as appropriate.

For example, the invention includes substantially the same configuration (for example, a configuration in which functions, methods, and results are the same, or a configuration in which objects and effects are the same) as the configuration described in the embodiment. The invention includes a configuration in which an inessential part of the configuration described in the embodiment is replaced with another part. The invention includes a configuration which achieves the same operation and effect or a configuration capable of achieving the same object as in the configuration described in the embodiment. The invention includes a configuration in which a well-known technique is added to the configuration described in the embodiment.

### REFERENCE SIGNS LIST

1 MOTION ANALYSIS SYSTEM

2 SUBJECT

3 GOLF CLUB

4 GOLF BALL

10 SENSOR UNIT

20 MOTION ANALYSIS APPARATUS

100 ACCELERATION SENSOR

110 ANGULAR VELOCITY SENSOR

120 SIGNAL PROCESSING SECTION

130 COMMUNICATION SECTION

200 PROCESSING SECTION

201 DATA ACQUISITION PORTION

202 ROTATION ANGLE COMPUTATION PORTION

203 INCLINED ANGLE COMPUTATION PORTION

204 INITIAL ATTITUDE INFORMATION GENERATION PORTION

205 MOTION ANALYSIS PORTION

206 ADVICE INFORMATION GENERATION PORTION

207 STORAGE PROCESSING PORTION

208 DISPLAY PROCESSING PORTION

209 SOUND OUTPUT PROCESSING PORTION

210 COMMUNICATION SECTION

220 OPERATION SECTION

230 ROM

240 RAM

250 RECORDING MEDIUM

260 DISPLAY SECTION

270 SOUND OUTPUT SECTION

1. A motion analysis method comprising:
a rotation angle computation step of computing a rotation angle about a long axis of a shaft of an exercise appliance when a subject holds the exercise appliance, by using outputs from an inertial sensor attached to the exercise appliance; and
an initial attitude information generation step of generating initial attitude information regarding an initial attitude of the exercise appliance by using the rotation angle.

2. The motion analysis method according to claim 1,
wherein, in a case where an attitude of the exercise appliance when the shaft is raised vertically to a hit ball target direction is set as a reference attitude, the rotation angle is a rotation angle about the long axis of the shaft of the exercise appliance in the initial attitude relative to the reference attitude.

3. The motion analysis method according to claim 2,
wherein the inertial sensor has a plurality of detection axes such as a first detection axis corresponding to the long axis direction of the shaft, a second detection axis corresponding to the hit ball target direction, and a third detection axis corresponding to a downward direction which is orthogonal to the first detection axis and the second detection axis, and
wherein, in the rotation angle computation step, the rotation angle is computed by using an acceleration in a direction of the second detection axis and an acceleration in a direction of the third detection axis, measured by the inertial sensor when the exercise appliance is in the initial attitude.

4. The motion analysis method according to claim 3, further comprising:
an inclined angle computation step of computing a combined acceleration of an acceleration in a direction of the first detection axis, the acceleration in the direction of the second detection axis, and the acceleration in the direction of the third detection axis, measured by the inertial sensor when the exercise appliance is in the initial attitude, and an inclined angle of the shaft is computed by using the acceleration in the direction of the first detection axis and the combined acceleration,
wherein, in the initial attitude information generation step, the initial attitude information is generated by using the inclined angle.

5. The motion analysis method according to claim 1, further comprising:
a motion analysis step of analyzing motion in which the subject has hit a ball with the exercise appliance, by using the initial attitude information and the outputs from the inertial sensor.

6. The motion analysis method according to claim 5,
wherein, in the motion analysis step, a combined value of the outputs from the inertial sensor is computed, and the time when the subject has hit the ball with the exercise appliance is specified on the basis of the combined value.

7. The motion analysis method according to claim 1, further comprising:
an advice information generation step of generating advice information regarding the way the subject holds the exercise appliance, by using the initial attitude information.

8. The motion analysis method according to claim 1,
wherein the exercise appliance is a golf club.

9. A motion analysis apparatus comprising:
a rotation angle computation portion computing a rotation angle about a long axis of a shaft of an exercise appliance when a subject holds the exercise appliance, by using outputs from an inertial sensor attached to the exercise appliance; and
an initial attitude information generation portion generating initial attitude information regarding an initial attitude of the exercise appliance by using the rotation angle.

10. A motion analysis system comprising:
the motion analysis apparatus according to claim 9; and
the inertial sensor.

11. A program causing a computer to execute:
a rotation angle computation step of computing a rotation angle about a long axis of a shaft of an exercise appliance when a subject holds the exercise appliance, by using outputs from an inertial sensor attached to the exercise appliance; and
an initial attitude information generation step of generating initial attitude information regarding an initial attitude of the exercise appliance by using the rotation angle.
